(19) United States
(12) Patent Application Publication
(10) Pub. No.: US 2026/0369885 A1
(43) Pub. Date: Nov. 19, 2026

(54) ANTENNA DEVICE

(71) Applicant: AISIN CORPORATION, Kariya, Aichi (JP)

(72) Inventors: Masaki MATSUSHIMA, Kariya-shi, Aichi-ken (JP); Hideyuki KANIE, Kariya-shi, Aichi-ken (JP); Tetsuya SHIOTSU, Kariya-shi, Aichi-ken (JP); Masaharu KUME, Kariya-shi, Aichi-ken (JP); Michihiro OGURA, Kariya-shi, Aichi-ken (JP)

(73) Assignee: AISIN CORPORATION, Kariya, Aichi (JP)

(21) Appl. No.: 19/471,217

(22) PCT Filed: Oct. 20, 2023
(86) PCT No.: PCT/JP2023/038048

§ 371 Date: Sep. 30, 2025

(30) Foreign Application Priority Data
May 24, 2023 (JP) 2023-085092

(51) Int. Cl. H01Q 9/04

(52) U.S. Cl. CPC H01Q 9/0414

(57) ABSTRACT

An antenna device includes: a board; a ground provided on a first surface of the board; an antenna having a quadrangular shape and provided on a second surface of the board; and a capacitor electrically connecting a corner of the antenna and the ground.

### CROSS REFERENCE TO RELATED APPLICATIONS

This is a National Stage Application of International Application No. PCT/JP 2023/038048 filed Oct. 20, 2023, claiming priority based on Japanese Patent Application No. 2023-085092 filed May 24, 2023.

### TECHNICAL FIELD

The present disclosure relates to an antenna device.

### BACKGROUND ART

In recent years, various antenna-related technologies have been developed. For example, Patent Document 1 discloses a patch antenna that can obtain a satisfactory gain even at a low elevation angle. The patch antenna disclosed in Patent Document 1 is structured by stacking a circuit board, a block-shaped dielectric member, and a radiating element in this order.

### Related Art Documents

### Patent Documents

Patent Document 1: Japanese Unexamined Patent Application Publication No. 2022-129251 (JP 2022-129251 A)

### SUMMARY OF THE DISCLOSURE

### Problem to be Solved by Various Aspects of the Disclosure

In the patch antenna disclosed in Patent Document 1, the circuit board, the dielectric member, and the radiating element are stacked. Therefore, the size of these components in the stacking direction increases. The patch antenna disclosed in Patent Document 1 includes the dielectric member that is larger in size in the stacking direction than a board. Therefore, there is a problem that the overall size of the patch antenna increases and the antenna device cannot be downsized.

The present disclosure has been made in view of the above problem, and has an object to provide an antenna device that can be downsized.

### Means for Solving the Problem

In view of the above, an antenna device is characterized by including: a board; a ground provided on a first surface of the board; an antenna having a quadrangular shape and provided on a second surface of the board; and a capacitor electrically connecting a corner of the antenna and the ground.

In this configuration, there is no need to dispose, on the board, a dielectric member that is larger than the board in size in a first direction orthogonal to the first surface of the board, thereby avoiding an increase in size in the first direction. Since the capacitor electrically connected to the ground is provided at the corner of the antenna, the capacitance of the capacitor produces a wavelength shortening effect. Thus, the frequency can be lowered. Therefore, the antenna device can be downsized.

### BRIEF DESCRIPTION OF THE DRAWINGS

FIG. 1 is a perspective view showing a configuration of an antenna device according to a first embodiment.

FIG. 2 is a sectional view taken along line II-II shown in FIG. 1.

FIG. 3 is a diagram showing a ground formation surface of a board shown in FIG. 1.

FIG. 4 is a diagram showing disposition of capacitors according to a modification of the first embodiment.

FIG. 5 is a diagram showing disposition of capacitors according to a modification of the first embodiment.

FIG. 6 is a diagram showing configurations of grounds according to modifications of the first embodiment.

FIG. 7 is a graph showing frequency characteristics of antenna devices structured using the grounds according to the first embodiment and the modifications.

FIG. 8 is a diagram showing an antenna device according to a modification of the first embodiment.

FIG. 9 is a diagram showing configurations of antenna devices according to modifications of the first embodiment and a comparative example.

FIG. 10 is a graph showing frequency characteristics of the antenna devices according to the modifications of the first embodiment and the comparative example.

FIG. 11 is a plan view showing a configuration of an antenna device according to a second embodiment.

FIG. 12 is a sectional view showing the configuration of the antenna device according to the second embodiment.

FIG. 13 is a plan view showing a first conductor layer according to the second embodiment.

FIG. 14 is a plan view showing a second conductor layer according to the second embodiment.

FIG. 15 is a plan view showing a third conductor layer according to the second embodiment.

FIG. 16 is a plan view showing a fourth conductor layer according to the second embodiment.

FIG. 17A is a diagram showing an equivalent circuit of the antenna device according to the second embodiment.

FIG. 17B is a diagram showing an equivalent circuit of the antenna device according to the second embodiment.

FIG. 18 is a plan view showing a third conductor layer according to a modification of the second embodiment.

FIG. 19 is a plan view showing a fourth conductor layer according to a modification of the second embodiment.

### DESCRIPTION OF EMBODIMENTS

Hereinafter, antenna devices according to embodiments will be described with reference to the drawings. However, the present disclosure is not limited to the following embodiments, and various modifications may be made without departing from the spirit of the present disclosure.

### First Embodiment

### Outline of Antenna Device

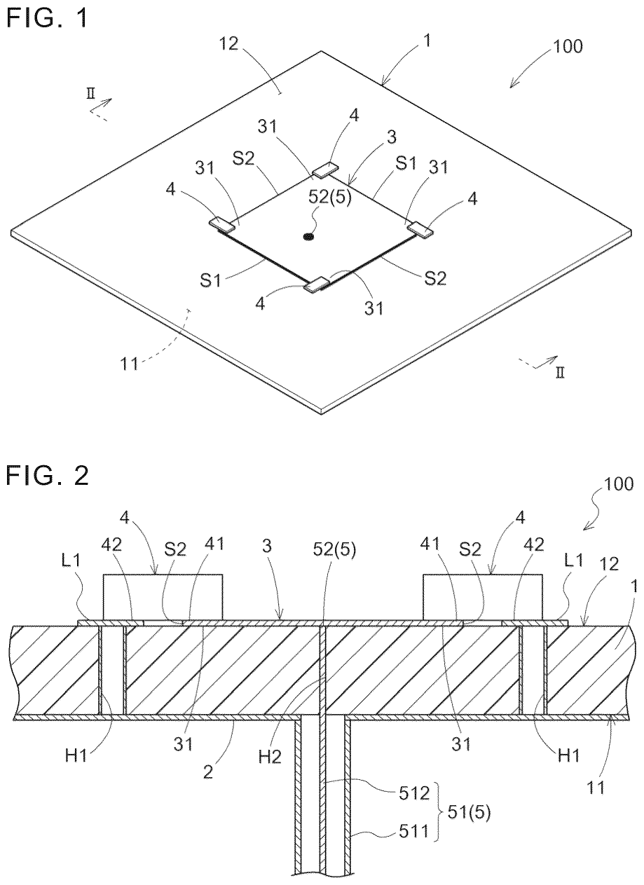

As shown in FIG. 1, an antenna device 100 is a patch antenna (microstrip antenna). FIG. 2 is a sectional view taken along line II-II shown in FIG. 1. As shown in FIGS. 1 and 2, the antenna device 100 includes a board 1, a ground 2 (see FIG. 2), an antenna element 3 (example of an antenna), four capacitors 4 (see FIG. 1), and a power supply unit 5. Although the posture of the antenna device 100 in use is not particularly limited, the side where the antenna element 3 is provided is referred to as an upper side and the opposite side is referred to as a lower side for ease of the following description.

The board 1 is a dielectric board made of a dielectric material. The board 1 is, for example, a glass epoxy board (FR4 board), and the dielectric constant of the dielectric material constituting the board 1 is, for example, 4 to 5.

The board 1 has a square shape as viewed in an up-down direction (hereinafter referred to as “plan view”) (see FIG. 1). The size of the board 1 can be changed as appropriate. The size of one side of the board 1 is, for example, 60 mm, and the size in the up-down direction is, for example, 1 to 1.5 mm.

The board 1 includes a lower surface 11 (example of a first surface) where the ground 2 is provided, and an upper surface 12 (example of a second surface) where the antenna element 3 is provided. Hereinafter, the lower surface 11 of the board 1 will be referred to as “ground formation surface 11” and the upper surface 12 will be referred to as “antenna formation surface 12.”

### Ground

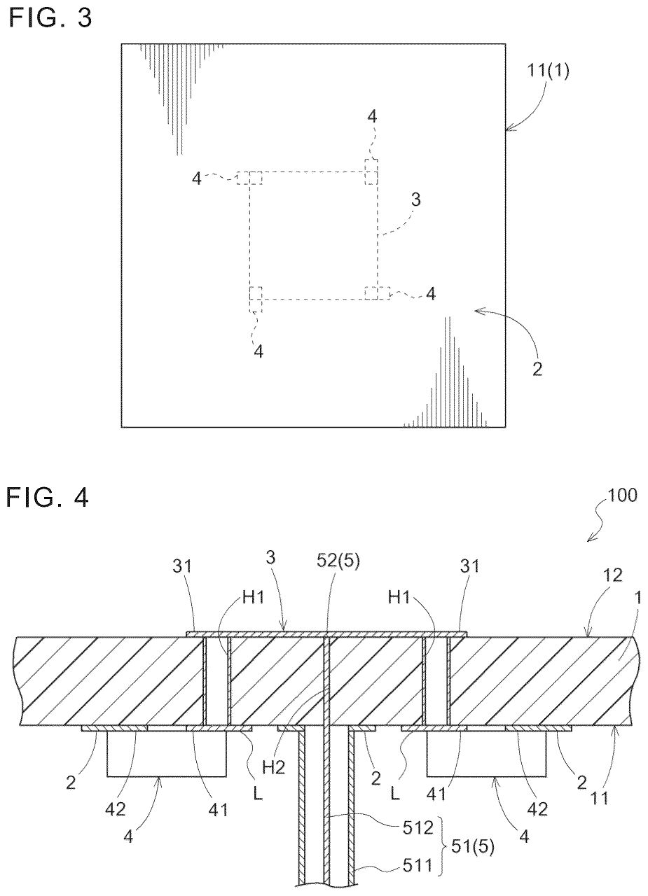

FIG. 3 is a diagram showing the ground formation surface 11 of the board 1 shown in FIG. 1. The long dashed double-short dashed lines shown in FIG. 3 indicate the outer edges of the antenna element 3 and the capacitors 4. As shown in FIGS. 2 and 3, the ground 2 is structured by forming a conductive pattern (hereinafter referred to as “ground pattern”) serving as the ground of the antenna device 100 on the ground formation surface 11. The ground pattern is made of a conductor such as silver or copper. In the present embodiment, the ground pattern is formed over the entire region of the ground formation surface 11 of the board 1. Hereinafter, the ground pattern formed on the entire region of the ground formation surface 11 of the board 1 may be referred to as “solid pattern.”

### Antenna Element

The antenna element 3 described with reference to FIGS. 1 and 2 can transmit or receive radio waves in a predetermined frequency band. In the present embodiment, the antenna element 3 transmits or receives radio waves in a frequency band (2.4 GHz wideband) conforming to the Bluetooth (registered trademark) standards.

The antenna element 3 is structured by forming a conductive pattern (hereinafter referred to as “antenna pattern”) on the antenna formation surface 12. The antenna pattern is made of a conductor such as silver or copper. As described above, the ground 2 is also made of a conductive pattern. That is, the ground 2 and the antenna element 3 are formed on a single printed circuit board.

As shown in FIG. 1, the antenna element 3 (antenna pattern) has a square shape (example of a quadrangular shape). In the present embodiment, the antenna element 3 is formed to be slightly smaller than the board 1, and the antenna element 3 is surrounded on all four sides by the board 1. The size of the antenna element 3 can be changed as appropriate. The length of one side is, for example, 20 mm.

The antenna element 3 includes first sides S1 parallel to each other, second sides S2 parallel to each other, and corners 31 where the first side S1 and the second side S2 intersect each other. The antenna element 3 includes four corners 31. Each of the corners 31 includes a vertex where each of the first sides S1 and each of the second sides S2 intersect each other, and the vicinity of the vertex. That is, the corner 31 is not limited to the corner at the vertex, but may be a portion closer to the corner at the vertex than to the center of each of the first sides S1 and the second sides S2. For example, the corner 31 refers to a portion closer to the corner at the vertex than to ⅓ of the end of each of the first sides S1 and the second sides S2.

### Capacitor

The four capacitors 4 are provided at the four corners 31 of the antenna element 3. In the present embodiment, each capacitor 4 is a chip capacitor. The size of each capacitor 4 in the up-down direction is smaller than the size of the board 1 in the up-down direction, and is, for example, 0.5 mm. Hereinafter, a capacitor 4 provided at a certain corner 31 will be referred to as “capacitor 4 corresponding to corner 31” and a corner 31 where a certain capacitor 4 is provided will be referred to as “corner 31 corresponding to capacitor 4.”

As shown in FIG. 2, the capacitors 4 are electrically connected to the ground 2 and the antenna element 3. More specifically, each capacitor 4 is electrically connected to the corresponding corner 31 of the antenna element 3. Each capacitor 4 is electrically connected to the ground 2 via a through hole H1 formed in the board 1. More specifically, each capacitor 4 includes a first electrode 41 on one side that is physically connected to the corner 31 of the antenna element 3, and a second electrode 42 on the other side that is physically connected to a land LI of the through hole H1. That is, each corner 31 of the antenna element 3 is electrically connected to the ground 2 via the corresponding capacitor 4.

In the present embodiment, the four capacitors 4 have the same configuration and are set to have equal capacitances. The capacitance of each capacitor 4 can be changed as appropriate, and is, for example, 2 pF (picofarads). Since the four capacitors 4 are set to have equal capacitances, linearly polarized radio waves are generated from the antenna element 3 in the present embodiment.

### Power Supply Unit

The power supply unit 5 includes a power supply line 51 for transmitting a high-frequency current. The power supply line 51 is, for example, a coaxial cable. The power supply line 51 includes a ground line 511 for connecting the ground 2 to the ground, and a signal line 512 for transmitting or receiving signals between a communication device (not shown) and the antenna element 3. The ground line 511 and the signal line 512 are made of conductors, and an insulating layer (not shown) is provided between the ground line 511 and the signal line 512.

The ground line 511 is connected to the ground 2. The signal line 512 is connected to the antenna element 3 via a through hole H2 extending through the board 1 in the up-down direction. Hereinafter, the connection point between the signal line 512 and the antenna element 3 will be referred to as “power supply point 52.”

As shown in FIG. 1, the power supply point 52 is provided at a position offset from the center point of the antenna element 3 (intersection of two diagonals of the antenna element 3) toward one first side S1 of the antenna element 3.

The antenna element 3 transmits, as a radio wave, a signal received from the above communication device via the signal line 512 (power supply point 52). When the antenna element 3 receives a radio wave, it transmits the received radio wave as a signal to the above communication device via the signal line 512 (power supply point 52).

### Functions and Effects of First Embodiment

As described above, according to the present embodiment, the four corners 31 (at farthest positions) of the antenna element 3 are connected to the ground 2 via the capacitors 4, thereby lowering the resonant frequency. Therefore, it is possible to structure the antenna device 100 that generates radio waves in the predetermined frequency band (Bluetooth (registered trademark) in the present embodiment). This eliminates the need to stack a block-shaped dielectric member on the board 1, thereby avoiding an increase in size in the up-down direction. That is, the antenna device 100 can be downsized.

A block-shaped dielectric member that is used in a general Bluetooth (registered trademark) antenna has a size of about 4 mm in the up-down direction. A block-shaped dielectric member that is used in a general GPS (Global Positioning System) antenna has a size of 5 to 7 mm in the up-down direction. In the antenna device 100 according to the present embodiment, the size of the capacitor 4 in the up-down direction is about 0.5 mm. Therefore, the antenna device 100 can be downsized.

In the present embodiment, the size of the capacitor 4 in the up-down direction is about 0.5 mm, and the size of the board 1 in the up-down direction is 1.5 mm. That is, the capacitor 4 is smaller in size in the up-down direction than the board 1. Therefore, the antenna device 100 can be downsized compared to a configuration in which a block-shaped dielectric member that is larger in size in the up-down direction than the board 1 is disposed on the board 1.

According to the present embodiment, the ground 2 and the antenna element 3 are made of conductive patterns. That is, the ground 2 and the antenna element 3 are formed on a single printed circuit board. Thus, manufacturing costs can be reduced.

### Modifications of First Embodiment

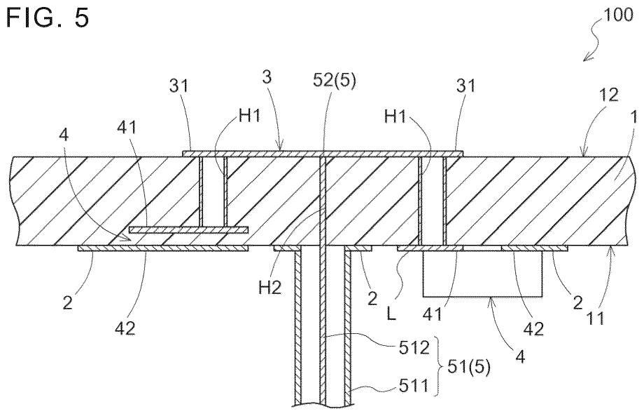

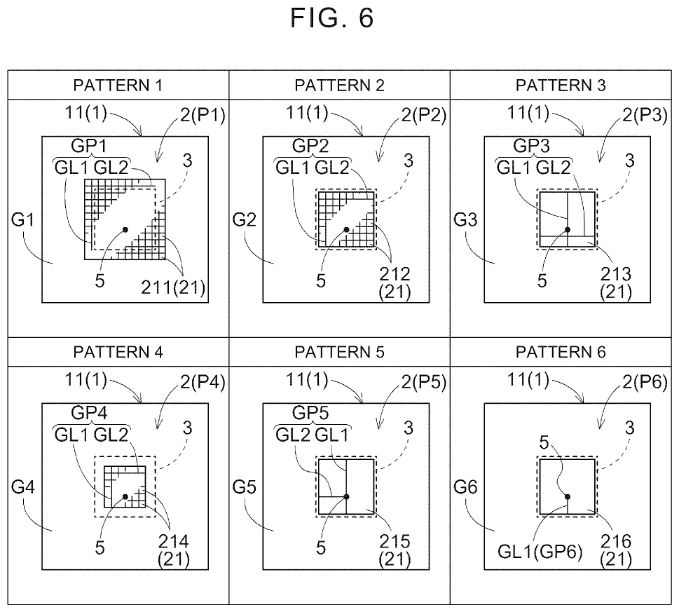

The present disclosure may be configured as follows in addition to the above embodiment (portions having the same functions as those of the above embodiment are denoted by the same numerals and signs as those of the above embodiment).
(1) In the above embodiment, the capacitors 4 are provided on the antenna formation surface 12 side of the board 1. However, the capacitors 4 may be such that the corresponding corners 31 of the antenna element 3 are electrically connected to the ground 2 via the capacitors 4. For example, as shown in FIG. 4, the capacitors 4 may be provided on the ground formation surface 11 side of the board 1. That is, the positions of the capacitors 4 may be selected in consideration of the relationship with peripheral devices in which the antenna device 100 is disposed. This improves the degree of freedom in designing the periphery of the antenna device 100.
(2) The above embodiment illustrates the case where the capacitors 4 are chip capacitors. As shown in FIG. 5, however, at least one of the capacitors 4 may be made of a conductive pattern and the other capacitors 4 may be chip capacitors. Alternatively, all the capacitors 4 may be made of conductive patterns. With all the capacitors 4 made of conductive patterns, the size of the antenna device 100 in the up-down direction can further be reduced (the height can be reduced). Since chip capacitors are not required, the costs required for the antenna device 100 can be reduced.
(3) The above embodiment illustrates the case where the capacitances of the four capacitors 4 are equal to each other. However, the capacitances of the capacitors 4 may be adjustable. The capacitance of at least one of the four capacitors 4 may be made different from the capacitances of the other capacitors 4. By changing the capacitance of the capacitor 4, the form of the polarized wave generated from the antenna element 3 can be changed. For example, the capacitance of one of the four capacitors 4 may be set different from the capacitances of the other three capacitors 4. Specifically, the capacitance of one capacitor 4 may be set smaller than the capacitances of the other three capacitors 4. Alternatively, the four capacitors 4 may be divided into two capacitor groups, and the capacitances of the capacitor groups may be set different from each other. The two capacitors 4 constituting one capacitor group are electrically connected to the corners 31 on the same diagonal of the antenna element 3, and are set to have equal capacitances. That is, the capacitances of the two capacitors 4 provided on one diagonal of the antenna element 3 are set equal to each other, and the capacitances of the two capacitors 4 provided on the other diagonal are set equal to each other. By setting the capacitance of at least one capacitor 4 to be different from those of the other capacitors 4, a circularly polarized radio wave can be generated in the antenna element 3. Therefore, the bandwidth of radio waves that can be transmitted and received by the antenna device 100 can be expanded. In particular, when the four capacitors 4 are divided into two capacitor groups and the capacitances of the capacitor groups are set different from each other, the bandwidth of radio waves that can be transmitted and received by the antenna device 100 can be expanded in a well-balanced manner.
(4) The above embodiment illustrates the case where the number of capacitors 4 is four. However, the number of capacitors 4 may be one to three.
(5) The above embodiment illustrates the case where the ground 2 is a solid pattern. However, the ground 2 need not be a solid pattern. For example, as shown in FIG. 6, the ground pattern of the ground 2 may include a ground-omitted region 21 (example of an opening) formed by omitting (e.g., cutting) the ground pattern. The ground-omitted region 21 is provided, for example, when the size of the board 1 is larger than the size of the ground 2. Thus, it is possible to improve the performance (in particular, the directivity) of the antenna element 3. Specifically, the antenna device 100 that is a patch antenna has a feature in that the ground 2 and the antenna element 3 are disposed close to each other in parallel and a high gain can be obtained in one direction (upward direction). If the ground 2 and the antenna element 3 are disposed excessively close to each other, however, the electric field generated between the ground 2 and the antenna element 3 may be confined, which may result in problems with antenna performance, such as a decrease in antenna efficiency and narrowing of the frequency band. Since the size of a general printed circuit board in the up-down direction is about 1 to 1.6 mm, in the configuration in which the ground 2 is provided on the lower surface 11 (ground formation surface 11) and the GHz-band antenna element 3 is provided on the upper surface 12 (antenna formation surface 12) as in the present embodiment, the ground 2 and the antenna element 3 may be disposed excessively close to each other as described above, which may result in problems with antenna performance, such as a decrease in antenna efficiency and narrowing of the frequency band. To avoid such problems, the common configuration is such that a dielectric member (dielectric member having a large size in the up-down direction) having an antenna pattern is mounted on a board as disclosed in Patent Document 1. In the present embodiment, however, the ground-omitted region 21 is provided in the ground 2. Therefore, a distance can be secured between the ground 2 and the antenna element 3, thereby avoiding the case where the ground 2 and the antenna element 3 are disposed excessively close to each other. As a result, the problems with antenna performance, such as a decrease in antenna efficiency and narrowing of the frequency band, can be avoided.

The ground pattern includes six patterns different in terms of the shape of the ground-omitted region 21. Hereinafter, the six patterns will be referred to as “first pattern P1” to “sixth pattern P6” and the ground-omitted regions 21 of the six patterns will be referred to as “first ground-omitted region 211” to “sixth ground-omitted region 216.” The long dashed double-short dashed lines shown in FIG. 6 indicate the outer edges of the antenna element 3.

The first pattern P1 includes a first pattern region GP1 having a mesh shape in a plan view, and a first outer ground region G1 (solid pattern) having an annular shape surrounding the first pattern region GP1. The first pattern region GP1 is structured by forming the first ground-omitted region 211. In a plan view, the outer edge of the first ground-omitted region 211 has a square shape, and is positioned outward of the outer edge of the antenna element 3 relative to the antenna element 3 (hereinafter simply referred to as “outward”). The first ground-omitted region 211 is composed of portions other than a plurality of first linear ground portions GLI each having a linear shape and parallel to the first side S1 (see FIG. 1) of the antenna element 3 and a plurality of second linear ground portions GL2 each having a linear shape and orthogonal to the first linear ground portions GL1. That is, the first pattern region GP1 is composed of the plurality of first linear ground portions GLI and the plurality of second linear ground portions GL2. The plurality of first linear ground portions GLI is provided at equal intervals in the direction in which the second linear ground portions GL2 extend. Both ends of the first linear ground portion GLI are connected to the first outer ground region G1. The plurality of second linear ground portions GL2 is provided at equal intervals in the direction in which the first linear ground portions GLI extend. Both ends of the second linear ground portion GL2 are connected to the first outer ground region G1. At least one of the first linear ground portion GLI and the second linear ground portion GL2 passes through the power supply unit 5 (is connected to the power supply unit 5).

The second pattern P2 includes a second pattern region GP2 having a mesh shape in a plan view, and a second outer ground region G2 (solid pattern) having an annular shape surrounding the second pattern region GP2. The second pattern region GP2 is structured in the same manner as the first pattern region GP1 except that the second pattern region GP2 is different in size from the first pattern region GP1. The outer edge of the second pattern region GP2 (second ground-omitted region 212) is positioned inward of the outer edge of the first pattern region GP1 (first ground-omitted region 211) relative to the antenna element 3 (hereinafter simply referred to as “inward”) in a plan view, and is formed to overlap the outer edge of the antenna element 3.

The third pattern P3 includes a third pattern region GP3 partitioned into four regions, and a third outer ground region G3 (solid pattern) having an annular shape surrounding the third pattern region GP3. The third pattern region GP3 is structured by forming the third ground-omitted region 213. In a plan view, the outer edge of the third ground-omitted region 213 has a square shape, and is formed to overlap the outer edge of the antenna element 3. The third ground-omitted region 213 is composed of portions other than one first linear ground portion GLI and one second linear ground portion GL2. That is, the third pattern region GP3 is composed of the one first linear ground portion GLI and the one second linear ground portion GL2. The first linear ground portion GLI passes through the power supply unit 5 (is connected to the power supply unit 5), and both ends are connected to the third outer ground region G3. The second linear ground portion GL2 intersects the first linear ground portion GLI at a position different from the position where the power supply unit 5 is provided. Both ends of the second linear ground portion GL2 are connected to the third outer ground region G3.

The fourth pattern P4 includes a fourth pattern region GP4 having a mesh shape in a plan view, and a fourth outer ground region G4 (solid pattern) having an annular shape surrounding the fourth pattern region GP4. The fourth pattern region GP4 is structured in the same manner as the first pattern region GP1 and the second pattern region GP2 except that the fourth pattern region GP4 is different in size in a plan view from the first pattern region GP1 and the second pattern region GP2. In a plan view, the outer edge of the fourth pattern region GP4 (fourth ground-omitted region 214) is positioned inward of the outer edge of the antenna element 3, and is even smaller than the second pattern region GP2 (second ground-omitted region 212).

The fifth pattern P5 includes a fifth pattern region GP5 partitioned into three regions, and a fifth outer ground region G5 (solid pattern) having an annular shape surrounding the fifth pattern region GP5. The fifth pattern region GP5 is structured by forming the fifth ground-omitted region 215. In a plan view, the outer edge of the fifth ground-omitted region 215 has a square shape, and is formed to overlap the outer edge of the antenna element 3. The fifth ground-omitted region 215 is composed of portions other than one first linear ground portion GLI and one second linear ground portion GL2. That is, the fifth pattern region GP5 is composed of the one first linear ground portion GLI and the one second linear ground portion GL2. The first linear ground portion GLI passes through the power supply unit 5 (is connected to the power supply unit 5), and is connected to the fifth outer ground region G5. The second linear ground portion GL2 is connected to the first linear ground portion GLI at a position where the power supply unit 5 is provided (connected at a right angle to the first linear ground portion GL1). The second linear ground portion GL2 has one end connected to the power supply unit 5 and the other end connected to the fifth outer ground region G5.

The sixth pattern P6 includes a sixth pattern region GP6 and a sixth outer ground region G6 (solid pattern) having an annular shape surrounding the sixth pattern region GP6. The sixth pattern region GP6 is structured by forming the sixth ground-omitted region 216. In a plan view, the outer edge of the sixth ground-omitted region 216 has a square shape, and is formed to overlap the outer edge of the antenna element 3. The sixth ground-omitted region 216 is composed of portions other than one first linear ground portion GL1. That is, the sixth pattern region GP6 is composed of the one first linear ground portion GL1. The first linear ground portion GLI has one end connected to the power supply unit 5 (ground line 511) and the other end connected to the sixth outer ground region G6.

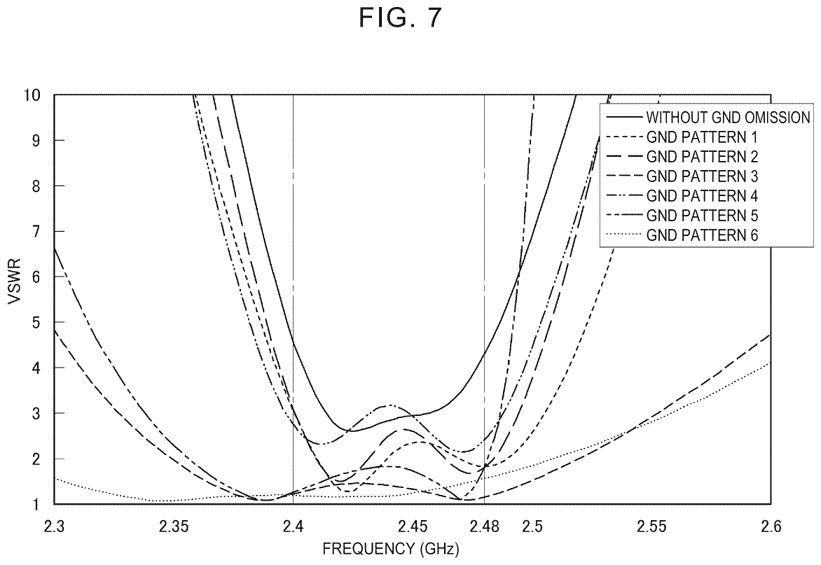

Referring to FIG. 7, description will be given of frequency characteristics of antenna devices 100 in the cases where the ground 2 includes the ground-omitted region 21 as described above and where the ground 2 does not include the ground-omitted region 21 (such that the entire region of the ground formation surface 11 is a conductive pattern) (without ground omission). FIG. 7 is a graph showing the frequency characteristics (simulation results) of the antenna devices 100. In FIG. 7, the horizontal axis represents a frequency (GHz), and the vertical axis represents a voltage standing wave ratio (VSWR).

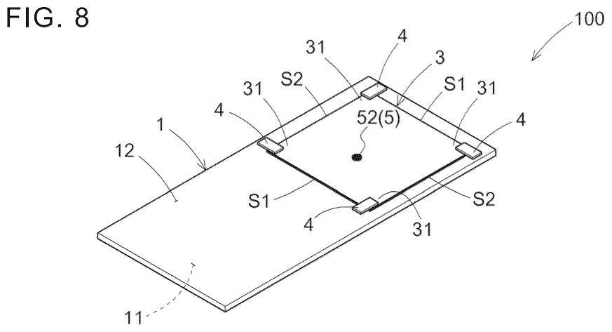

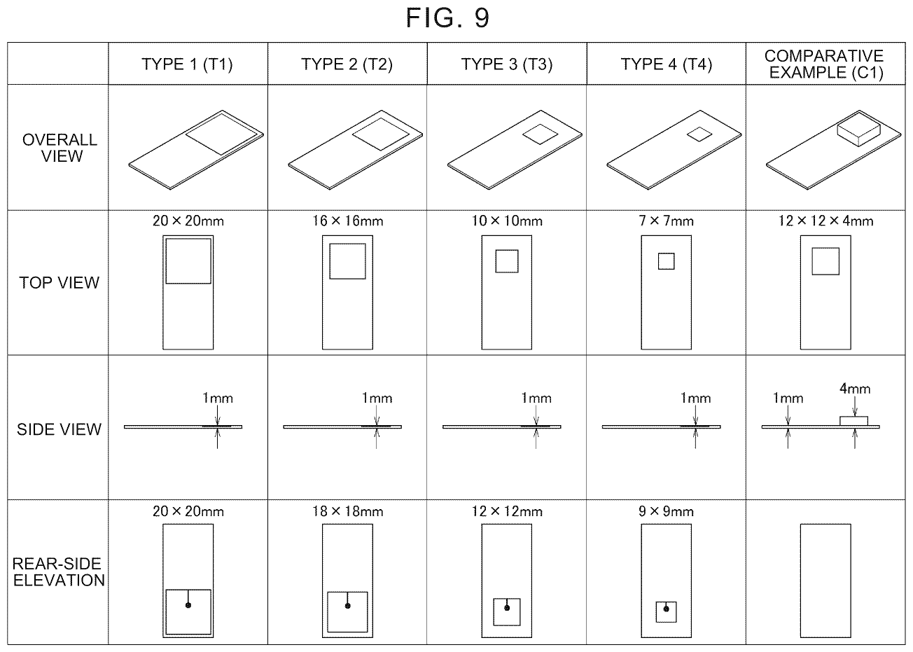

As shown in FIG. 7, in the frequency band (2.4 GHz to 2.48 GHz) that is used for Bluetooth (registered trademark), the VSWR value is equal to or less than “3” substantially for all the patterns, thereby indicating that satisfactory results are obtained in terms of the performance of the antenna device 100. It is also shown that the VSWR value decreases as the size of the ground-omitted region 21 increases. The frequency band (2.4 GHz to 2.48 GHz) that is used for Bluetooth (registered trademark) includes frequency bands in which the VSWR value is not equal to or less than “3” for the ground 2 that does not include the ground-omitted region 21 (without ground omission) and for the ground 2 structured in the fourth pattern P4. It is understood that there is no problem with antenna performance.
(6) The above embodiment illustrates the example in which the antenna device 100 includes the capacitors 4. However, the capacitors 4 can be omitted from the antenna device 100 when the ground 2 includes the ground-omitted region 21 (the ground 2 has a predetermined pattern). In particular, when the ground 2 has a pattern similar to the sixth pattern P6, the capacitors 4 may be omitted (see a first type T1 in FIG. 9).
(7) In the above embodiment, the antenna element 3 has the square shape. However, the shape of the antenna element 3 is not limited to the square shape and may be a rectangular shape. It is preferable that the side length ratio (long side/short side) of the antenna element 3 be, for example, 1.5 or less. Although the board 1 also has the square shape, the shape and size can be changed as appropriate. For example, the board 1 may have a rectangular shape (first type T1 to fourth type T4 shown in FIGS. 8 and 9). In this case, the length of one side of the board 1 may be equal to or different from the length of the first side S1 of the antenna element 3, and can be changed as appropriate depending on the size of the antenna element 3. Thus, the antenna device 100 can be downsized.

Hereinafter, configurations of antenna devices 100 including boards 1 having different shapes and sizes will be described with reference to FIG. 9. An antenna device 100 of the first type T1 shown in FIG. 9 corresponds to an antenna device 100 shown in FIG. 8 from which the capacitors 4 are omitted and in which the ground pattern of the ground 2 is the sixth pattern P6 (see FIG. 6). In the first type T1, the size of one side of the antenna element 3 is 20 mm, and the size of one side of the ground-omitted region 21 of the ground 2 is 20 mm.

Antenna devices 100 of the second type T2 to the fourth type T4 each correspond to the antenna device 100 shown in FIG. 8 that is changed in sizes of the ground 2 and the antenna element 3. Specifically, the size of one side of the antenna element 3 is 16 mm in the second type T2, 10 mm in the third type T3, and 7 mm in the fourth type T4. The ground pattern of the ground 2 is similar to the sixth pattern P6 (the outer edge of the ground-omitted region 21 is positioned outward of the outer edge of the antenna element 3). The size of one side of the ground pattern is 18 mm in the second type T2, 12 mm in the third type T3, and 9 mm in the fourth type T4.

The length of the board 1 of each of the antenna devices 100 of the first type T1 to the fourth type T4 in the up-down direction is 1 mm, and the size in a plan view (long side x short side) is 50 mm×22 mm. In the antenna devices 100 of the second type T2 to the fourth type T4, the four corners 31 of the antenna element 3 and the capacitors 4 are electrically connected to each other.

In an antenna device according to a comparative example C1 shown in FIG. 9, a dielectric member (block-shaped dielectric member) is disposed on a board, the antenna portion has a square shape in a plan view with each side having a size of 12 mm, and the size of the antenna portion in the up-down direction is 4 mm. In the antenna device according to the comparative example C1, the ground does not include a ground-omitted region (opening).

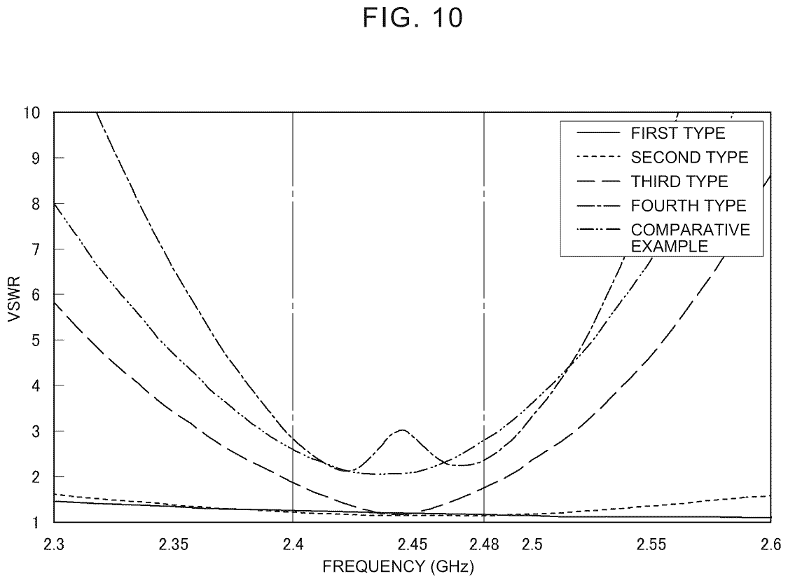

Hereinafter, antenna characteristics of the antenna devices 100 of the first type T1 to the fourth type T4 and the antenna device according to the comparative example C1 will be described with reference to FIG. 10.

FIG. 10 is a graph showing frequency characteristics (simulation results) of the antenna devices 100 according to the modifications of the first embodiment and the antenna device according to the comparative example. In FIG. 10, the horizontal axis represents a frequency (GHz), and the vertical axis represents a voltage standing wave ratio (VSWR).

As shown in FIG. 10, in the frequency band (2.4 GHz to 2.48 GHz) that is used for Bluetooth (registered trademark), the VSWR value is equal to or less than “3” substantially for all the types, thereby indicating that satisfactory results are obtained in terms of the performance of the antenna device 100. In particular, in the first type Tl to the third type T3, the VSWR values are lower than that in the comparative example C1, thereby indicating that satisfactory results are obtained in terms of the performance of the antenna device 100.
(8) The above embodiment illustrates the case where the antenna element 3 is the antenna that can transmit or receive radio waves in the frequency band conforming to the Bluetooth (registered trademark) standards. However, the antenna element 3 may be an antenna that can transmit or receive radio waves in a frequency band conforming to, for example, the GPS standards.

### Second Embodiment

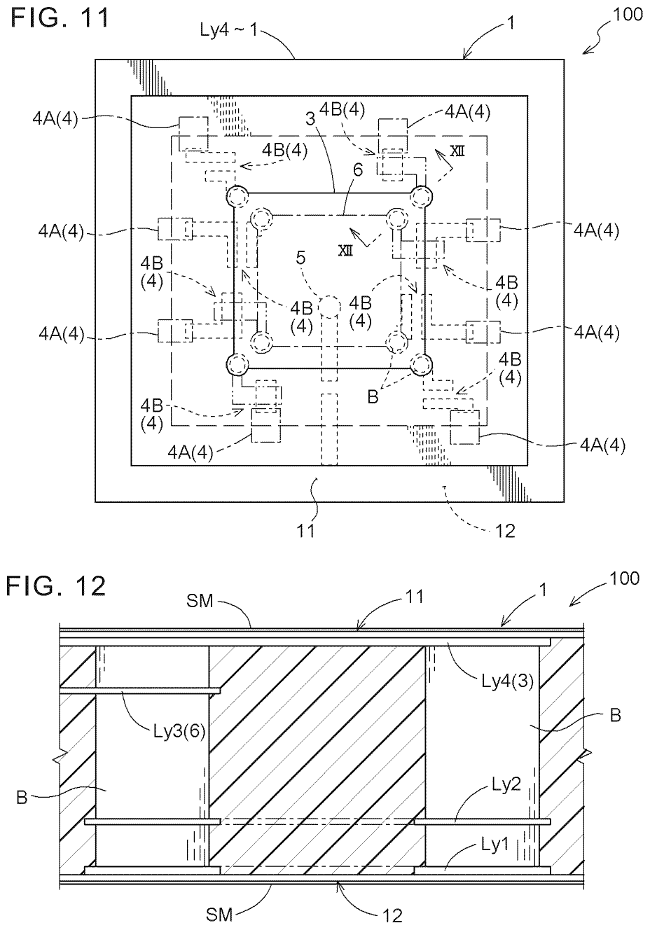

Next, an antenna device 100 according to a second embodiment will be described with reference to FIGS. 11 to 19. The second embodiment is different from the first embodiment in that the board 1 is a multilayer board including three or more conductor layers (see FIG. 12) and the antenna device 100 further includes an antenna element 6 different from the antenna element 3. Hereinafter, the antenna element 3 (example of the antenna) will be referred to as “first antenna element 3” and the antenna element 6 (example of a second antenna) different from the antenna element 3 will be referred to as “second antenna element 6.” The first antenna element 3 and the second antenna element 6 are provided on different conductor layers (see FIG. 12).

As shown in FIG. 11, in the second embodiment, the first antenna element 3 and the second antenna element 6 each have a square shape in a plan view as in the first embodiment. In the present embodiment, the size (area) of the first antenna element 3 (see FIG. 11) is larger than the size (area) of the second antenna element 6 in a plan view. The sizes of the first antenna element 3 and the second antenna element 6 may be changed as appropriate. The length of one side of the first antenna element 3 is, for example, 4 mm, and the length of one side of the second antenna element 6 is, for example, 3×3 mm. The antenna device 100 is a UWB (Ultra Wide Band) antenna that resonates at the above two frequencies. The first antenna element 3 can transmit or receive radio waves in a first frequency band (e.g., 6.5 GHz or 8 GHz). The second antenna element 6 can transmit or receive radio waves in a second frequency band (e.g., 8 GHz or 6.5 GHZ). In the second embodiment, the board 1 has a quadrangular shape of, for example, 18 mm×18 mm (see FIG. 11).

As shown in FIG. 11, in the second embodiment, the capacitors 4 (capacitances) include chip capacitors and conductive patterns. Hereinafter, the capacitor 4 that is a chip capacitor will be referred to as “chip capacitor 4A” and the capacitor 4 that is a conductive pattern will be referred to as “pattern capacitor 4B.” The pattern capacitor 4B has a smaller capacitance than the chip capacitor 4A. The pattern capacitor 4B is used, for example, to adjust the capacitance.

### Board

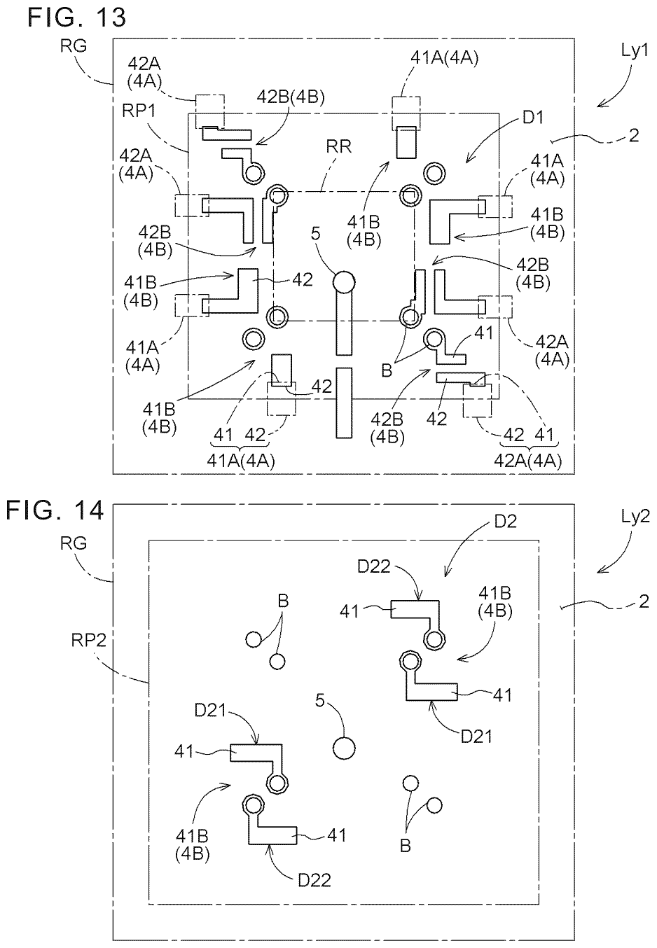

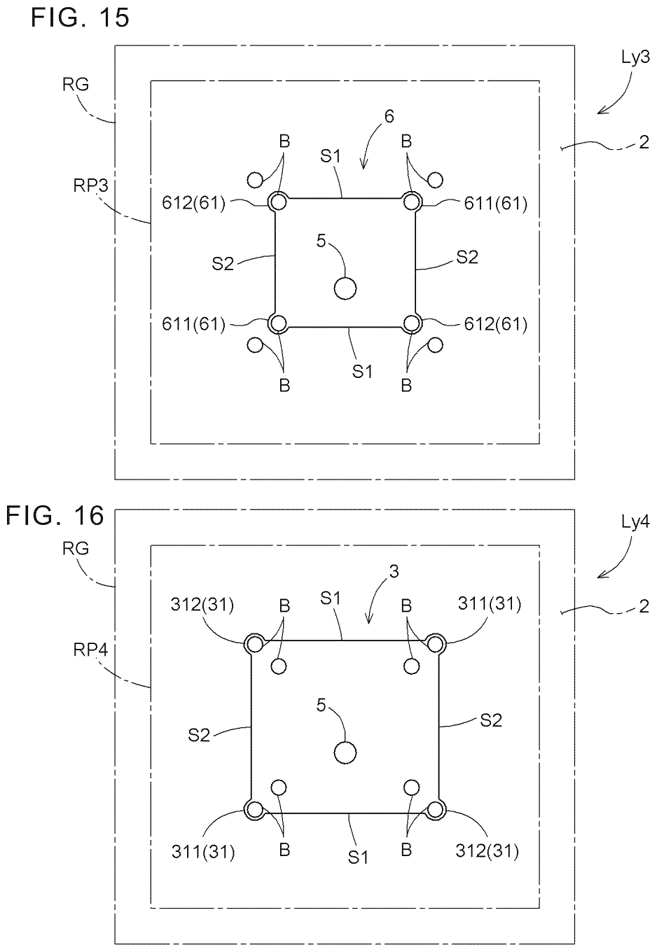

As shown in FIGS. 11 to 16, in the present embodiment, the board 1 includes four conductor layers. Hereinafter, the four conductor layers will be referred to, in order from the bottom, as “first conductor layer Ly1” (see FIG. 13), “second conductor layer Ly2” (see FIG. 14), “third conductor layer Ly3” (see FIG. 15), and “fourth conductor layer Ly4” (see FIG. 16). In FIG. 11, the conductive pattern formed in the first conductor layer Ly1 is indicated by dashed lines, the conductive pattern formed in the second conductor layer Ly2 is indicated by long dashed double-short dashed lines, the conductive pattern formed in the third conductor layer Ly3 is indicated by long dashed short dashed lines, and the conductive pattern formed in the fourth conductor layer Ly4 is indicated by continuous lines. In the present embodiment, the lower surface of the first conductor layer Ly1 is an example of the first surface, the upper surface of the fourth conductor layer Ly4 is an example of the second surface, and the third conductor layer Ly3 is an example of an intermediate layer.

The length (hereinafter referred to as “thickness”) of the first conductor layer Ly1 shown in FIG. 12 in the up-down direction is, for example, 0.043 mm. The thickness of the second conductor layer Ly2 is, for example, 0.032 mm. The thickness of the third conductor layer Ly3 is, for example, 0.032 mm. The thickness of the fourth conductor layer Ly4 is 0.043 mm. The lower surface of the first conductor layer Ly1 and the upper surface of the fourth conductor layer Ly4 may each be covered with a solder mask SM. The thickness of the solder mask SM is, for example, 0.020 mm.

Insulating layers each made of a dielectric material such as glass epoxy (dielectric constant of the dielectric material is, for example, 4 to 5) are provided between the first conductor layer Ly1 and the second conductor layer Ly2, between the second conductor layer Ly2 and the third conductor layer Ly3, and between the third conductor layer Ly3 and the fourth conductor layer Ly4. The thickness of the insulating layer between the first conductor layer Ly 1 and the second conductor layer Ly2 is, for example, 0.198 mm. The thickness of the insulating layer between the second conductor layer Ly2 and the third conductor layer Ly3 is, for example, 0.6 mm. The thickness of the insulating layer between the third conductor layer Ly3 and the fourth conductor layer Ly4 is, for example, 0.198 mm.

### First Conductor Layer

As shown in FIG. 13, the first conductor layer Ly1 is provided with the ground 2. In the present embodiment, the first conductor layer Ly1 includes a first-layer pattern formation region RP1 and a ground region RG disposed in an annular shape to surround the first-layer pattern formation region RP1. The ground region RG includes the first-layer pattern formation region RP1 in the central portion. The outer dimensions of the ground region RG are 10 mm×10 mm, and the distance between the ground region RG and the outer edge of the board 1 is, for example, 4 mm. The outer dimensions of the first-layer pattern formation region RP1 are 6.5 mm×6.5 mm.

In the first-layer pattern formation region RP1, a conductive pattern is formed to electrically connect either the third conductor layer Ly3 or the fourth conductor layer Ly4 to the ground 2 via the capacitors 4 (in the present embodiment, the chip capacitor 4A and the pattern capacitor 4B shown in FIG. 11). Hereinafter, the conductive pattern formed in the first-layer pattern formation region RP1 will be referred to as “first-layer pattern D1.” The third conductor layer Ly3 or the fourth conductor layer Ly4 is electrically connected to the first-layer pattern D1 through vias B. In the present embodiment, the via B extends through the board 1, but the via B need not extend through the board 1.

The first-layer pattern D1 includes conductive patterns functioning as the pattern capacitors 4B. In the present embodiment, the pattern capacitors 4B include a first pattern capacitor 41B made of conductive patterns in the first conductor layer Ly1 and the second conductor layer Ly2, and a second pattern capacitor 42B made of conductive patterns formed in the first conductor layer Ly1. In the conductive patterns constituting the second pattern capacitor 42B in the first-layer pattern D1, a conductive pattern functioning as the first electrode 41 of the second pattern capacitor 42B and a conductive pattern functioning as the second electrode 42 of the second pattern capacitor 42B are disposed to face each other in a direction orthogonal to the up-down direction (direction included in the lower surface 11).

The ground region RG is provided in an annular shape along the edge of the board 1. The ground region RG is provided with a ground pattern serving as the ground 2 of the antenna device 100. In the present embodiment, the ground pattern is a solid pattern.

The ground pattern is electrically connected to the first-layer pattern D1 via eight chip capacitors 4A. Specifically, one electrode (second electrode 42) of each chip capacitor 4A is electrically connected to the ground pattern, and the other electrode (first electrode 41) is electrically connected to the first-layer pattern D1. In the present embodiment, the eight chip capacitors 4A have equal capacitance values. The eight chip capacitors 4A are disposed, for example, in the first conductor layer Ly 1.

The eight chip capacitors 4A include four first chip capacitors 41A connected to the first pattern capacitors 41B and four second chip capacitors 42A connected to the second pattern capacitors 42B.

Each of the four first chip capacitors 41A is electrically connected to the first antenna element 3 or the second antenna element 6 via the first pattern capacitor 41B. Each of the four second chip capacitors 42A is electrically connected to the first antenna element 3 or the second antenna element 6 via the second pattern capacitor 42B.

### Second Conductor Layer

As shown in FIG. 14, the second conductor layer Ly2 is provided with a conductive pattern as one electrode of the first pattern capacitor 41B. The second conductor layer Ly2 includes a second-layer pattern formation region RP2 and a ground region RG disposed in an annular shape to surround the second-layer pattern formation region RP2. The ground region RG is electrically connected to the ground 2 (ground region RG) provided in the first conductor layer Ly1 through vias B (not shown).

In the second-layer pattern formation region RP2, a conductive pattern (hereinafter referred to as “second-layer pattern D2”) is formed. The second-layer pattern D2 functions as the electrodes (first electrodes 41) of the first pattern capacitors 41B. Specifically, the second-layer pattern D2 includes a portion that faces, in the up-down direction across the insulating layer, the first-layer pattern D1 functioning as the electrodes (second electrodes 42) of the first pattern capacitors 41B provided in the first conductor layer Ly1 described with reference to FIG. 13.

The second-layer pattern D2 includes second-layer inner patterns D21 provided on the inner side of the second-layer pattern D2 (near the center of the antenna device 100 in a plan view), and second-layer outer patterns D22 provided on the outer side.

The second-layer inner patterns D21 are electrically connected to the antenna element having a smaller size (area) in a plan view (in the present embodiment, the second antenna element 6) out of the two antenna elements (first antenna element 3 and second antenna element 6) provided in the third conductor layer Ly3 and the fourth conductor layer Ly4. The second-layer outer patterns D22 are electrically connected to the antenna element having a larger size (area) (in the present embodiment, the first antenna element 3).

### Third Conductor Layer

As shown in FIG. 15, the third conductor layer Ly3 is provided with the second antenna element 6. In the present embodiment, the third conductor layer Ly3 includes a third-layer pattern formation region RP3 and a ground region RG disposed in an annular shape to surround the third-layer pattern formation region RP3.

The second antenna element 6 is provided in the third-layer pattern formation region RP3. The second antenna element 6 is structured by forming a conductive pattern (hereinafter referred to as “second antenna pattern”). The first-layer pattern formation region RP1 shown in FIG. 13 includes an overlap region RR that overlaps the second antenna element 6 in a plan view, and an omitted region (region where the first-layer pattern D1 is not formed) is formed in at least part of the overlap region RR. Therefore, confinement of electric flux lines between the first antenna element 3 and the second antenna element 6 is suppressed, and radio waves can be radiated efficiently. The overlap region RR is a region immediately below the antenna element having a smaller size in a plan view (in the present embodiment, the second antenna element 6) out of the second antenna element 6 and the first antenna element 3.

In the present embodiment, the second antenna element 6 (second antenna pattern) is formed in the center of the third conductor layer Ly3 to be spaced away from the ground region RG. In the present embodiment, the second antenna pattern is formed as a solid pattern having a square shape in a plan view.

The second antenna element 6 includes first sides S1 parallel to each other, second sides S2 parallel to each other, and four first corners 61 where the first side S1 and the second side S2 intersect each other. Each of the first corners 61 includes a vertex where the first side S1 and the second side S2 intersect each other, and the vicinity of the vertex. That is, the first corner 61 is not limited to the corner at the vertex, but may be a portion closer to the corner at the vertex than to the center of each of the first sides S1 and the second sides S2. For example, the first corner 61 refers to a portion closer to the corner at the vertex than to ⅓ of the end of each of the first sides S1 and the second sides S2.

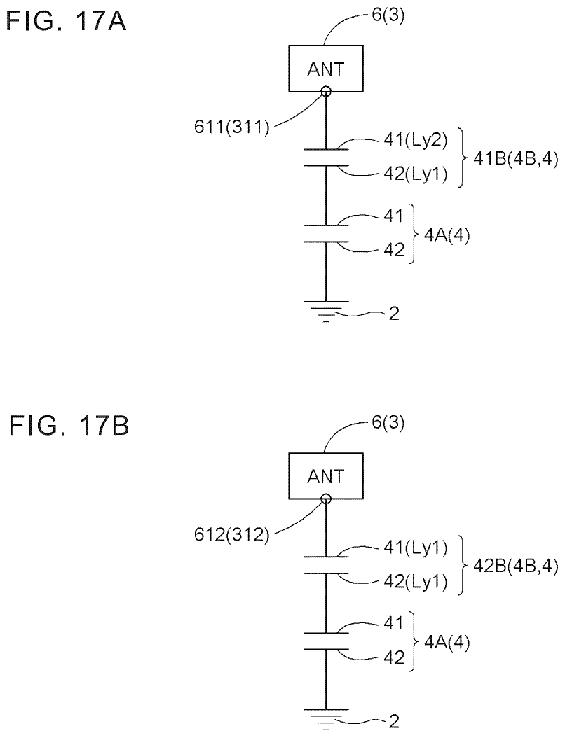

In the present embodiment, two second corners 611 provided on one diagonal out of the four first corners 61 are electrically connected through the vias B to the second-layer inner patterns D21 provided in the second conductor layer Ly2 described with reference to FIG. 14. As described above, the second-layer inner patterns D21 constitute the first pattern capacitors 41B via the insulating layer and the first-layer pattern D1 provided in the first conductor layer Ly 1. The first pattern capacitor 41B is electrically connected to the chip capacitor 4A, and the chip capacitor 4A is electrically connected to the ground 2. That is, as shown in the equivalent circuit in FIG. 17A, each of the two second corners 611 is connected to the ground 2 via the first pattern capacitor 41B and the chip capacitor 4A.

Two third corners 612 provided on the other diagonal out of the four first corners 61 shown in FIG. 15 are electrically connected through the vias B to the conductive patterns constituting the second pattern capacitors 42B of the first-layer pattern D1 provided in the first conductor layer Ly1 described with reference to FIG. 13. The second pattern capacitor 42B is electrically connected to the chip capacitor 4A, and the chip capacitor 4A is electrically connected to the ground 2. That is, as shown in FIG. 17B, each of the two third corners 612 is connected to the ground 2 via the second pattern capacitor 42B and the chip capacitor 4A.

The ground region RG (outer periphery of the second antenna element 6) shown in FIG. 15 is electrically connected to the ground 2 (ground region RG) provided in the first conductor layer Ly1 through vias B (not shown). Thus, influence of noise can be reduced.

### Fourth Conductor Layer

As shown in FIG. 16, the fourth conductor layer Ly4 is provided with the first antenna element 3. In the present embodiment, the fourth conductor layer Ly4 includes a fourth-layer pattern formation region RP4 and a ground region RG disposed in an annular shape to surround the fourth-layer pattern formation region RP4.

The first antenna element 3 is provided in the fourth-layer pattern formation region RP4. The first antenna element 3 is structured by forming a conductive pattern (hereinafter referred to as “first antenna pattern”). That is, the ground 2, the first antenna element 3, and the second antenna element 6 are formed on a single printed circuit board.

In the present embodiment, the first antenna element 3 (first antenna pattern) is formed in the center of the fourth conductor layer Ly4 to be spaced away from the ground region RG. In the present embodiment, the first antenna pattern is formed as a solid pattern having a square shape in a plan view. The first antenna element 3 is insulated from four inner vias B shown in FIG. 16 and is not electrically connected to the four inner vias B.

The first antenna element 3 includes the first sides S1 parallel to each other, the second sides S2 parallel to each other, and the four corners 31 where the first side S1 and the second side S2 intersect each other. Hereinafter, the four corners 31 will be referred to as “fourth corners 31.” Each of the fourth corners 31 includes a vertex where the first side S1 and the second side S2 intersect each other, and the vicinity of the vertex. That is, the fourth corner 31 is not limited to the corner at the vertex, but may be a portion closer to the corner at the vertex than to the center of each of the first sides S1 and the second sides S2. For example, the fourth corner 31 refers to a portion closer to the corner at the vertex than to ⅓ of the end of each of the first sides S1 and the second sides S2.

In the present embodiment, two fifth corners 311 provided on one diagonal out of the four fourth corners 31 are electrically connected through the vias B to the second-layer outer patterns D22 provided in the second conductor layer Ly2 described with reference to FIG. 14. As described above, the second-layer outer patterns D22 constitute the first pattern capacitors 41B via the insulating layer and the first-layer pattern D1 provided in the first conductor layer Ly 1. The first pattern capacitor 41B is electrically connected to the chip capacitor 4A, and the chip capacitor 4A is electrically connected to the ground 2. That is, as shown in the equivalent circuit in FIG. 17A, each of the two fifth corners 311 is connected to the ground 2 via the pattern capacitor 4B and the chip capacitor 4A.

Two sixth corners 312 provided on the other diagonal out of the four fourth corners 31 shown in FIG. 16 are electrically connected through the vias B to the conductive patterns constituting the second pattern capacitors 42B of the first-layer pattern D1 provided in the first conductor layer Ly1 described with reference to FIG. 13. The second pattern capacitor 42B is electrically connected to the chip capacitor 4A, and the chip capacitor 4A is electrically connected to the ground 2. That is, as shown in FIG. 17B, each of the two sixth corners 312 is connected to the ground 2 via the second pattern capacitor 42B and the chip capacitor 4A.

The ground region RG (outer periphery of the second antenna element 6) shown in FIG. 16 is electrically connected to the ground 2 (ground region RG) provided in the first conductor layer Ly1 through vias B (not shown). Thus, influence of noise can be reduced.

### Modifications of Second Embodiment

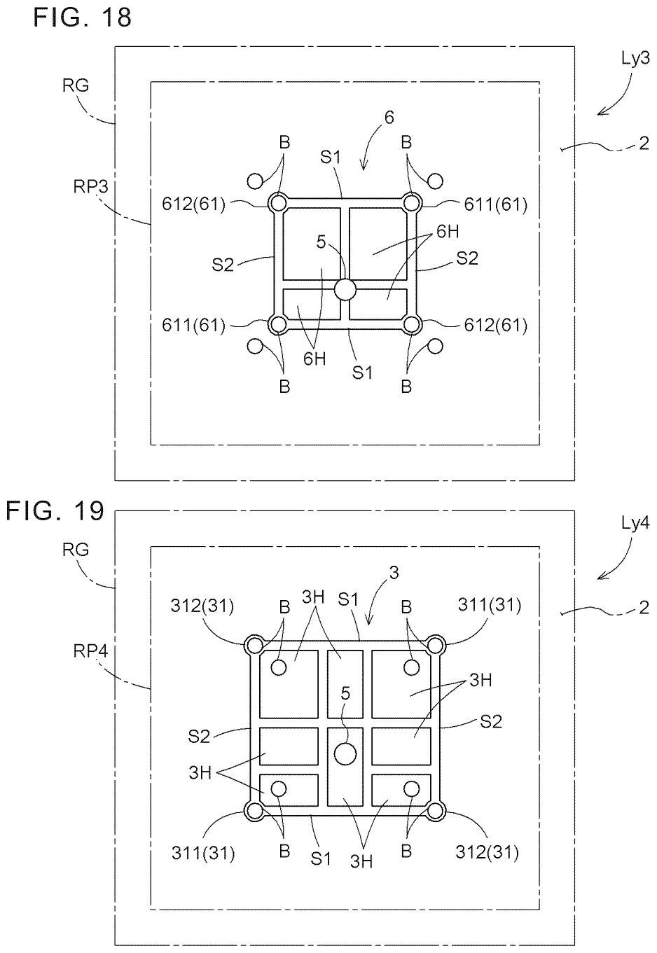

(1) The second embodiment illustrates the case where the board 1 is the board including the four conductor layers. However, the board 1 is not limited to the board including the four conductor layers. The board 1 may include five or more conductor layers, or may include three conductor layers. When the board 1 includes three conductor layers, for example, the second conductor layer Ly2 (first pattern capacitors 41B) is omitted.
(2) In the second embodiment, the first antenna element 3 is provided in the first conductor layer Ly1, and the second antenna element 6 is provided in the second conductor layer Ly2. However, the conductor layers where the first antenna element 3 and the second antenna element 6 are provided can be interchanged. Specifically, the second antenna element 6 may be provided in the first conductor layer Ly1, and the first antenna element 3 may be provided in the second conductor layer Ly2.
(3) The second embodiment illustrates the case where the first antenna element 3 and the second antenna element 6 each have the square shape in a plan view. However, the first antenna element 3 and the second antenna element 6 may each have any quadrangular shape with a long side-to-short side ratio of 1.5 or less.
(4) As shown in FIG. 18, the second antenna element 6 may have second antenna openings 6H. That is, the second antenna element 6 is not limited to being made of the solid pattern, and may be made of a lattice-shaped conductive pattern. Even with the second antenna openings 6H, the same effects can be obtained as in the case where the second antenna openings 6H are not provided. Similarly, as shown in FIG. 19, the first antenna element 3 may have first antenna openings 3H. The same applies to the effects.
(5) In the second embodiment, both the first antenna element 3 and the second antenna element 6 are electrically connected to the ground 2 via the capacitances (chip capacitors 4A and/or pattern capacitors 4B). However, it is sufficient when at least one of the first antenna element 3 and the second antenna element 6 is electrically connected to the ground 2 via the capacitances (chip capacitors 4A and/or pattern capacitors 4B).
(6) In the second embodiment, all of the four fourth corners 31 of the first antenna element 3 are electrically connected to the ground 2 via the capacitances (chip capacitors 4A and/or pattern capacitors 4B). However, only two of the fourth corners 31 may be electrically connected to the ground 2 via the capacitances (chip capacitors 4A and/or pattern capacitors 4B). The two fourth corners 31 are the fourth corners 31 located on one or the other diagonal. The same applies to the second antenna element 6.
(7) As described in the modification of the first embodiment, the positions of the chip capacitors 4A may be selected in consideration of the relationship with peripheral devices. This improves the degree of freedom in designing the periphery of the antenna device 100.
(8) In the above embodiment, the capacitors 4 include the pattern capacitors 4B that are the conductive patterns as well as the chip capacitors 4A. However, the capacitors 4 may be either the chip capacitors 4A or the pattern capacitors 4B. The capacitances of the chip capacitors 4A may or may not be equal. For example, the capacitance of the chip capacitor 4A electrically connected to the fifth corner 311 of the first antenna element 3 may be different from the capacitance of the chip capacitor 4A electrically connected to the sixth corner 312 of the first antenna element 3. The same applies to the pattern capacitors 4B.
(9) The second embodiment illustrates the case where the omitted region is formed in the overlap region RR of the first conductor layer Ly1. However, the omitted region need not be formed in the overlap region RR.
(10) The second embodiment illustrates the case where the ground region RG is formed as the solid pattern. As described in the modification of the first embodiment, however, the ground 2 may include the ground-omitted region 21 of any of the six ground patterns.
(11) The configurations disclosed in the above embodiments can be applied in combination with any of the configurations disclosed in the other embodiments as long as no contradiction arises. Regarding the other configurations as well, the embodiments disclosed herein are merely illustrative in all respects. Therefore, various modifications can be made as appropriate without departing from the spirit of the present disclosure.

The following configurations are possible for the above embodiments.
(1) The antenna device 100 according to the present disclosure is characterized by including: the board 1; the ground 2 provided on the ground formation surface 11 (first surface) of the board 1; the antenna element 3 (antenna) having a quadrangular shape and provided on the antenna formation surface 12 (second surface) of the board 1; and the capacitor 4 electrically connecting the corner 31 of the antenna element 3 (antenna) and the ground 2.

In this configuration, there is no need to dispose, on the board 1, a dielectric member that is larger than the board 1 in size in the up-down direction (first direction) orthogonal to the lower surface 11 of the board 1, thereby avoiding an increase in size in the up-down direction (first direction). Since the capacitor 4 electrically connected to the ground 2 is provided at the corner 31 of the antenna element 3 (antenna), the capacitance of the capacitor 4 produces a wavelength shortening effect. Thus, the frequency can be lowered. Therefore, the antenna device 100 can be downsized.
(2) In the antenna device 100 according to (1), the ground 2 may have an opening.

In this configuration, the ground 2 has the opening. Therefore, the capacitive coupling between the antenna element 3 (antenna) and the ground 2 is reduced, thereby improving the performance of the antenna element 3 (antenna).
(3) In the antenna device 100 according to (1) or (2), the ground 2 and the antenna element 3 (antenna) may be formed on a single printed circuit board.

In this configuration, the ground 2 and the antenna element 3 (antenna) are formed on the single board 1. Therefore, the manufacturing costs can be reduced.
(4) In the antenna device 100 according to (1) or (2), the four capacitors 4 may be electrically connected to the four corners 31 of the antenna element 3 (antenna), and the capacitance of at least one of the four capacitors 4 may be different from the capacitances of the other of the capacitors 4.

In this configuration, the capacitance of at least one capacitor 4 is made different from the capacitances of the other capacitors 4. Therefore, a circularly polarized radio wave can be generated, thereby expanding the bandwidth of radio waves that can be transmitted and received.
(5) In the antenna device 100 according to (1) or (2), the capacitances of two capacitors 4 provided on one diagonal of the antenna out of the four capacitors 4 may be equal to each other, and the capacitances of two capacitors 4 provided on the other diagonal may be equal to each other.

In this configuration, the four capacitors 4 are divided into two capacitor groups and the capacitances of the capacitor groups are set different from each other. Therefore, the bandwidth of radio waves that can be transmitted and received can be expanded in a well-balanced manner.
(6) In the antenna device 100 according to (1) or (2), the board 1 may be a multilayer board, the antenna device 100 may further include the second antenna element 6 (second antenna) different from the first antenna element 3 (antenna), and the second antenna element 6 (second antenna) may be provided in the third conductor layer Ly3 (intermediate layer) between the first surface 11 and the second surface 12 of the board 1.

In this configuration, the board 1 is the multilayer board 1. Therefore, the plurality of antenna elements can be provided. Thus, it is possible to cause resonance in a plurality of frequency bands.
(7) In the antenna device 100 according to (5), the ground 2, the antenna element 3 (antenna), and the second antenna element 6 (second antenna) may be formed on a single printed circuit board.

In this configuration, the ground 2, the antenna element 3 (antenna), and the second antenna element 6 (second antenna) can be formed on the single printed circuit board. Therefore, the manufacturing costs can be reduced.
(8) In the antenna device 100 according to (5), the capacitor 4 may electrically connect the corner 61 of the second antenna element 6 (second antenna) and the ground 2.

In this configuration, there is no need to dispose, on the board 1, a dielectric member that is larger than the board 1 in size in the up-down direction (first direction) orthogonal to the ground formation surface 11 (first surface) of the board 1, thereby avoiding an increase in size in the up-down direction (first direction). Since the capacitor 4 electrically connected to the ground 2 is provided at the corner 61 of the second antenna element 6 (second antenna), the capacitance of the capacitor 4 produces a wavelength shortening effect. Thus, the frequency can be lowered. Therefore, the antenna device 100 can be downsized.
(9) In the antenna device 100 according to (1), the capacitor 4 may be the chip capacitor 4A and/or the pattern capacitor 4B (conductive pattern).

In this configuration, the capacitor 4 can be selected depending on the position in consideration of the relationship with peripheral devices in which the antenna device 100 is disposed, thereby improving the degree of freedom in designing the periphery of the antenna device 100. Further, a desired capacitance can be set easily.

### INDUSTRIAL APPLICABILITY

The technology according to the present disclosure can be used in an antenna device.

### DESCRIPTION OF THE REFERENCE NUMERALS

1: board, 2: ground, 3: first antenna element (antenna), 4: capacitor, 6: second antenna element (second antenna), 11: ground formation surface (first surface), 12: antenna formation surface (second surface), 21: ground-omitted region (opening), 31: fourth corner, 61: first corner, 100: antenna device (blockless patch antenna device)

1. An antenna device comprising:
a board;
a ground provided on a first surface of the board;
an antenna having a quadrangular shape and provided on a second surface of the board; and
a capacitor electrically connecting a corner of the antenna and the ground.

2. The antenna device according to claim 1, wherein the ground includes an opening.

3. The antenna device according to claim 1, wherein the ground and the antenna are formed on a single printed circuit board.

4. The antenna device according to claim 1, wherein:
four of the capacitors are electrically connected to four of the corners of the antenna; and
a capacitance of at least one of the four of the capacitors is different from capacitances of the other of the capacitors.

5. The antenna device according to claim 1, wherein:
the board is a multilayer board;
the antenna device further includes a second antenna different from the antenna; and
the second antenna is provided in an intermediate layer between the first surface and the second surface of the board.

6. The antenna device according to claim 5, wherein the ground, the antenna, and the second antenna are formed on a single printed circuit board.

7. The antenna device according to claim 5, wherein the capacitor electrically connects a corner of the second antenna and the ground.

8. The antenna device according to claim 1, wherein the capacitor is a chip capacitor and/or a conductive pattern.

9. The antenna device according to claim 2, wherein the ground and the antenna are formed on a single printed circuit board.

10. The antenna device according to claim 2, wherein:
four of the capacitors are electrically connected to four of the corners of the antenna; and
a capacitance of at least one of the four of the capacitors is different from capacitances of the other of the capacitors.

11. The antenna device according to claim 2, wherein:
the board is a multilayer board;
the antenna device further includes a second antenna different from the antenna; and
the second antenna is provided in an intermediate layer between the first surface and the second surface of the board.

12. The antenna device according to claim 11, wherein the ground, the antenna, and the second antenna are formed on a single printed circuit board.

13. The antenna device according to claim 11, wherein the capacitor electrically connects a corner of the second antenna and the ground.
